(19) United States
(12) Patent Application Publication
(10) Pub. No.: US 2016/0119462 A1
(43) Pub. Date: Apr. 28, 2016

(54) INTERACTIVE WATCH BAND

(71) Applicant: Jay Goldstein, Deerfield, IL (US)

(72) Inventor: Jay Goldstein, Deerfield, IL (US)

(21) Appl. No.: 14/920,558

(22) Filed: Oct. 22, 2015

Related U.S. Application Data
(60) Provisional application No. 62/068,238, filed on Oct. 24, 2014.

(51) Int. Cl. H04M 1/725; H04W 68/00; H04W 4/00

(52) U.S. Cl. CPC H04M 1/7253; H04W 4/008; H04W 68/005

(57) ABSTRACT

An apparatus including a wrist band that encircles the wrist of a human user, a processor of the wrist band that wirelessly monitors a cellphone carried by the human user for a notification of a message and a type of message received by the cellphone and a vibrating element of the wrist band having a plurality of different activation patterns saved in a memory that notifies the human user via a vibration pattern as to the type of message received by retrieving and executing one of the plurality of different activation patterns based upon the type of message received.

This application is a continuation-in-part of U.S. Provisional Patent No. 62/068,238 filed on Oct. 24, 2014.

### FIELD

This application relates to cellphones and more particular to the control of cellphones.

### BACKGROUND

Cellphones are a part of everyday life. People often carry cellphones for convenience of contact with business associates and friends.

Cellphones are offered under any of a number of different formats. In its simplest form, a cellphone may only allow a user to receive and place voice calls.

More sophisticated phones (e.g., I-phones, Android, etc.) may also provide Internet access. Internet access greatly expands the capabilities of cellphones by also allowing a user to search for a telephone number of a called party, even if the user does not initially have that number in his possession.

In conjunction with Internet service, many cellphones also provide access to e-mail. In addition to receiving e-mail, a user can also compose and send e-mails to desired destinations.

Instant messaging is also a convenient feature offered on many smartphones. Instant messaging allows a user to send short messages without the effort required by e-mails.

Many phones also provide the ability for users to create and save contact lists of friends and business associates within the cellphone. Associated with each contact may be a home and/or a cellphone telephone number where a person can be most easily found.

While cellphones have greatly improved the mobility of many people, they are also a distraction. For example, in the past, when a call was received on a cellphone, the user would often have to search through the user's purse or pockets for the cellphone. This could present a serious risk for a person driving a car.

One solution to this problem is simply to turn the cellphone off. However, this is not a viable option where a user must be available for incoming calls. Accordingly, a need exists for better ways of handling incoming calls.

### BRIEF DESCRIPTION OF THE DRAWINGS

FIG. 1 is a side view of a cellphone system in accordance herewith; and

FIG. 2 is a simplified block diagram of the control elements of the system of FIG. 1.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

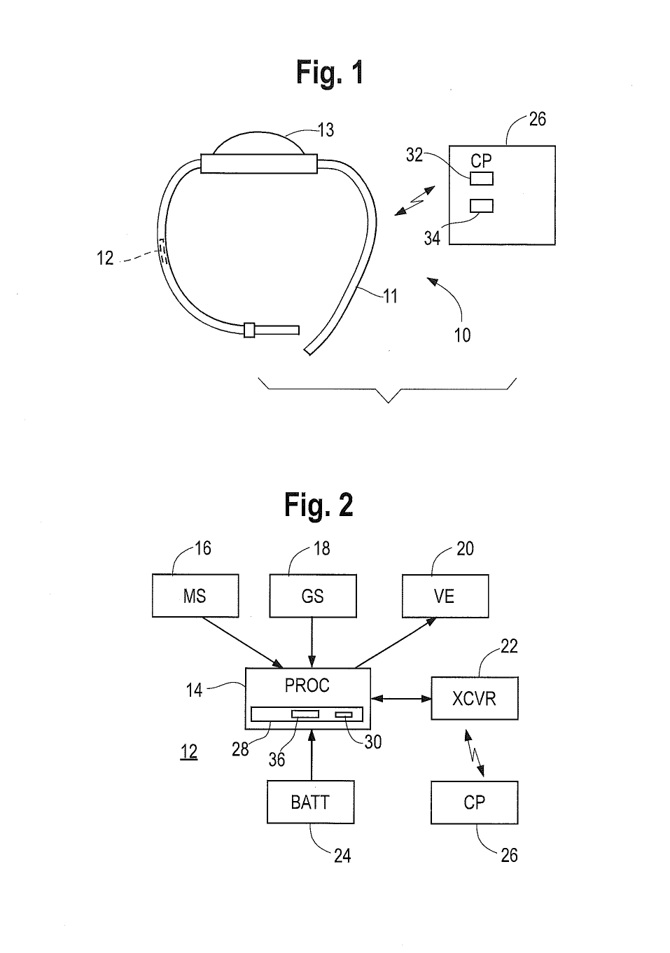

FIG. 1 depicts a cellphone system 10 shown generally in accordance with an illustrated embodiment. Included within the system is a wristband 11 and cellphone 26. The wristband may include a watch 13 (in which case the wristband is a watchband) or the wristband may simply be provided as a loop that encircles the wrist of a human user.

Included within the watchband is a processing module 12. The processing module includes a number of hardware elements that allow the user to interact with and control the cellphone through operation of those elements.

For example, the watchband may incorporate a processor 14, a motion sensor 16, a gyroscopic sensor 18, a vibrating element 20, a radio frequency transceiver 22 and energy source 24. While FIG. 2 shows only a single processor, it is to be understood that the cellphone, and the elements of the processing module may each include any number of processor apparatus (processors) and where each processsor operates under control of one or more computer programs 30 loaded from a non-transitory computer readable medium (memory) 28. As used herein reference to a step of a computer program is also reference to the processor that executed that step

During normal operation, the radio frequency transceiver forms a short range data connection (e.g., using Bluetooth) with a cellphone carried by a user. Utilizing the data connection with the cellphone, the watchband is able to notify the user of various events (e.g., call arrival, e-mail arrival, etc.) using the vibrating element. The vibrating element is capable of creating any of a number of user recognizable patterns that allows the user to differentiate between various event types. The user is able to send feedback to the cellphone based upon hand (wrist) movement detected by the motion sensor and/or gyroscopic sensor. A processor identifies these predefined acts (e.g., hand motions, taps) of a user as respective indicators of the intended disposition of each event. The processor then sends commands to the cellphone based upon the type of motion detected.

Included within the cellphone is a companion application (app) 32 executing on a processor of the cellphone that identifies and classifies incoming contacts from other human users (e.g., callers) based upon the type of contact involved. The contact may be classified into respective types based upon the source and format of the contact. One or more classification files 34 may contain a contact profile that defines the various types based upon the source and format of the contact. For example, a voice call from the user's mother may be assigned a contact type that results in the greatest priority being given to that type of contact.

On another level, the determination of the type of contact may be based upon the identity of the source of the contact. In this case, a list of human sources may be listed in one of the classification files as being a person from whom the user of the cellphone will preferentially accept calls. If the caller is not on the list, then the companion processor rejects the call by simply not answering the call or by returning a busy signal.

On another level, the typing of the contact may be based upon the format of the contact. In this case, a voice call may be assigned to a first type of contact while an instant message or e-mail may be assigned to second and third types.

In general, the companion app (or a related app) within the cellphone may determine a type of each contact based upon a combination of the identity and the format of the contact. Once a type is determined, the companion app or related app assigns a code to the contact and sends a notification to the processor of the wrist band including the code of the determined type of contact.

Included within the wrist band is a memory 28 including a number of different vibration patterns 30 used to activate the vibrating element. Each different vibration pattern in memory corresponds to one of the type codes generated by the companion processor and sent to the wrist band. For example, a voice call from the user's boss could be defined by a vibration pattern include two ¼ second long periods of activation that are ½ second apart followed by one second pause. Similarly, a voice call from the user's mother could include 1 second activation periods separated by a ½ second pause.

In this regard, the vibration element is held against the skin of the user by the wrist band. Accordingly, any vibration pattern is acutely felt by the user.

Also included within memory is a number of instruction files 36 that define one or more instructions that may be sent to the companion processor or related processor of the cellphone. Included within each instruction file is an instruction along with a wrist motion that triggers the sending of that instruction to the cellphone. In this regard, the instruction defines how the cellphone is to process the call (e.g., answer the call, send it to voice mail, etc.).

Wrist motion is detected by motion and/or gyroscopic sensor. In this regard, a processor of the wrist band detects the motion of the wrist of the user via the motion and/or gyroscopic sensor and compares the detected motion with a predefined wrist motion defined within each of the instruction files. Upon detecting a match the processor retrieves the instruction from the matched file and sends the instruction to the companion app within the cellphone. The cellphone executes that instruction to further process the call. For example (and using the example above), if the contact is a call from the user's boss, then two 180 degree rotations of the user's wrist within two seconds may signal the cellphone that the user wants to accept the call. Upon receiving the instruction, the cellphone completes the voice connection between the caller (i.e., the user's boss) and the user. Similarly, a back-and-forth horizontal motion of the user's hand parallel to the body of the user caused by rotation of the user's forearm from the elbow may be an indication that the call is to be refused or sent to voice mail.

In another embodiment, the wrist band may be used to detect a misplaced cellphone. In this case, signal strength may be used to trigger a vibration pattern that indicates to the user that the user has inadvertently placed his cellphone at some stationary location and is walking away.

In general, the wrist module is a self-contained, self-powered accessory to a traditional watch body. The module of the band is capable of pairing and securely communicating via a Bluetooth low energy protocol (e.g., BT 4.0) with any compatible mobile phone. Once paired, a phone based companion app will provide command and control of the accessory and visa versa. The app will also manage how and when given indicators of events are transmitted to the accessory and in turn to the end user via the vibration element.

The band enables smartwatch-like-features such as event notifications, as configured by the user on the companion app and alarms such as lost phone notification to be privately sent to a human user. Biometric sensors and other consumer health functionality may be added and enabled on the wrist band making it a multipurpose device able to act as both an active phone accessory and a passive collector of data.

Under illustrated embodiments, the wrist band is a product that is capable of interacting with the wearer via subtle, non-intrusive “hapcons.” In this regard, hapcons enable the wearer to be notified of ongoing events on his/her mobile phone. With simple easy to remember gestures, the wearer can provide acknowledgement or control through the wrist band and hence to the mobile phone.

In some embodiments, the wrist band uses a self contained power source that either does not require recharging or is capable of charging through passive means (e.g., kinetic energy, energy harvesting, etc.). Replaceable or rechargeable battery configurations may be used.

Notifications sent to the wrist band from the companion application may be summarized as follows for an incoming contact. First the phone companion app receives an incoming call event from the phone operating system (OS). The companion app validates that incoming caller is on the current important contacts filter list (provided by the user) in the cellphone. If the caller is on the important contacts list and this type of event is enabled, an incoming call notification is sent to the wrist band (hereinafter also sometimes referred to as a “smartband” or “smart band”).

An incoming call end state may be considered next. In this case, the phone companion app receives an event indicating that the ringing state has been exited (e.g., either silenced, hung up or answered). This may occur because the user has independently taken control of the call through the keyboard of the cellphone. Upon detecting this state, the companion app will send an incoming call end notification to the smart band if the app is currently in the incoming call state.

If the phone receives an incoming call notification cancel from the smart band, the companion app will check to see what action to take. Based on user settings, the phone will either silence the ring or divert the call directly to voice mail. Optionally, based on user settings, the phone will send a preset message to the incoming caller number.

An incoming message (e.g., an instant message, e-mail, etc.) may be considered next. In this case, the companion app receives an incoming message event from the phone OS. The companion app validates that incoming message source is on the current important contacts filter list. If the source is on the important contacts list and this type of event is enabled, an incoming message notification is sent to the smartband.

The initial powering up of the system may be considered next. Upon power up of the cellphone, the companion app will connect and send a power up notification to the smartband. When phone is powering down, the companion app will attempt to send the power down notification to the smartband.

Notifications processed by the smartband may be considered next. In the case of an incoming call begin state, the smartband shall begin playing the stored “incoming call” notification upon receipt of the incoming call notification from the paired device. In this case, playing the incoming call notification means activating the vibrating element in accordance with a vibration pattern corresponding to the incoming call. The smartband shall continue to play this notification until the user acknowledges the call, until the incoming call end message is received or a 120 second timer expires.

In the case of an incoming call end state, if the smart band is currently playing the incoming call notification, and the incoming call end notification is received, the band shall become idle (enter an idle state) immediately. If the smart band has sent the cancel call notification message, the notification shall have already ended but the smartband will now return to the idle mode.

In the case of an incoming message, the smart band may respond appropriately. If the smartband receives an incoming message notification, the smart band shall play the incoming message notification once.

The lost phone state may be considered next. If connection to the secure paired device becomes relatively weak (as judged by receipt of medium strength signal), the device shall play the lost phone warning every 15 seconds. If the connection to the secure paired device becomes very weak (judged as far), the device shall play the lost phone warning every 5 seconds. If connection to the phone is lost, the smart shall play the lost phone warning continuously. The user can cancel the lost phone notification via a cancel notice gesture.

Incoming call notifications can be canceled at any time. The user can cancel the incoming call notification via a cancel notice gesture to the device. The device (smart band) will send a call notification cancel to the paired device (cellphone).

Power down notification may also be provided. If the smartband receives the power down notification in the idle state, the smartband will ignore the lost contact until a power up notification is received. The phone will enter a special phone disconnected idle state. If the smartband receives the power down notification while in the lost phone state, the lost phone state will immediately change to a disconnected lost phone state. When power up notification is received, the smartband will begin monitoring for a lost phone and normal idle state.

In general, the system includes a wrist band that encircles the wrist of a human user, a processor of the wrist band that wirelessly monitors a cellphone carried by the human user for a notification of a message and a type of message received by the cellphone and a vibrating element of the wrist band having a plurality of different activation patterns saved in a memory that notifies the human user via a vibration pattern as to the type of message received by retrieving and executing one of the plurality of different activation patterns based upon the type of message received.

Alternatively, the system includes a wrist band that encircles the wrist of a human user, a processor of the wrist band that wirelessly monitors a cellphone carried by the human user for calls from human callers, a vibrating element of the wrist band having a plurality of different activation patterns saved in a memory that notifies the human user of a call from a human caller via one of the plurality of vibration patterns and a processor of the wrist band that detects a predetermined hand motion of the human user in response to the call via the wrist band and sends a predetermined instruction associated with the hand motion to the cellphone for handling the call.

Alternatively, the system includes a cellphone carried by a human user, a wrist band that encircles the wrist of the human user, a processor of the wrist band that wirelessly monitors a cellphone carried by the human user for a type of call received from a human caller, a vibrating element of the wrist band having a plurality of different activation patterns saved in a memory, the processor of the wrist band selects one of the plurality of activation patterns based upon the type of call and notifies the human user of the call received from the human caller via the selected vibration pattern and a processor of the wrist band that detects one of a plurality of predetermined hand motions of the human user in response to the call via a motion sensor within the wrist band and sends a predetermined instruction associated with the detected hand motion to the cellphone for handling the call.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a wrist band that encircles the wrist of a human user;
a processor of the wrist band that wirelessly monitors a cellphone carried by the human user for a notification of a message and a type of message received by the cellphone; and
a vibrating element of the wrist band having a plurality of different activation patterns saved in a memory that notifies the human user via a vibration pattern as to the type of message received by retrieving and executing one of the plurality of different activation patterns based upon the type of message received.

2. The apparatus as in claim 1 wherein the cellphone further comprises an I-phone.

3. The apparatus as in claim 1 wherein the type of message further comprises a voice call.

4. The apparatus as in claim 1 further comprising a radio frequency transceiver of the wrist band that monitors the cellphone via a Bluetooth connection.

5. The apparatus as in claim 1 wherein the type of message further comprises one of an e-mail and instant message.

6. The apparatus as in claim 1 further comprising a plurality of respective cellphone commands saved in a memory of the processor of the wrist band, each of the commands being associated with a specific predetermined movement of a user's wrist saved in memory along with the command.

7. The apparatus as in claim 6 further comprising one of a gyroscopic sensor and motion sensor that detects movements of the wrist band.

8. The apparatus as in claim 7 further comprising a processor of the wrist band that receives detected movements of the user's wrist from the one of the gyroscopic sensor and motion sensor, compares the detected movements with the movement associated with each of the plurality of commands, selects one of the plurality of commands based upon a match between the detected movements and predetermined movement and sends the selected command to the cellphone.

9. The apparatus as in claim 6 wherein one of the plurality of commands instructs the cellphone to send a voice call to voice mail.

10. The apparatus as in claim 9 wherein the predetermined movement associated with sending the call to voice mail further comprises a relatively rapid 180 degree rotation of the user's wrist.

11. The apparatus as in claim 1 further comprising a motion activated power source of the wrist band that generates power in response to movement of the user's wrist.

12. The apparatus as in claim 1 further comprising a companion application executing on a processor of the cellphone that accepts incoming calls from human callers in a contacts filter list and rejects calls not found within the list.

13. The apparatus as in claim 12 further comprising a feature of the companion application that sends the notification message notifying the user of the wrist band of a incoming call from an approved caller to the processor of the wrist band.

14. An apparatus comprising:
a wrist band that encircles the wrist of a human user;
a processor of the wrist band that wirelessly monitors a cellphone carried by the human user for calls from human callers;
a vibrating element of the wrist band having a plurality of different activation patterns saved in a memory that notifies the human user of a call from a human caller via one of the plurality of vibration patterns; and
a processor of the wrist band that detects a predetermined hand motion of the human user in response to the call via the wrist band and sends a predetermined instruction associated with the hand motion to the cellphone for handling the call.

15. The apparatus as in claim 14 further comprising a corresponding application executing on a processor of the cellphone that classifies each incoming calls into one of a plurality of types based upon a set of characteristics of the call.

16. The apparatus as in claim 14 further comprising a feature of the corresponding application that determines a type of the call of the plurality of types by comparing the characteristics of the call with one or more lists of characteristics and forwards a notification of the determined type of the incoming call to the processor of the wrist band.

17. The apparatus as in claim 16 further comprising a processor of the wrist band that selects one of the plurality of activation patterns based upon the determined type.

18. The apparatus as in claim 14 wherein the predetermined instruction for handling the call further comprises sending the call to voice mail.

19. The apparatus as in claim 14 further comprising a processor of the wrist band that forms a Bluetooth connection with the cellphone.

20. An apparatus comprising:
a cellphone carried by a human user;
a wrist band that encircles the wrist of the human user;
a processor of the wrist band that wirelessly monitors a cellphone carried by the human user for a type of call received from a human caller;
a vibrating element of the wrist band having a plurality of different activation patterns saved in a memory, the processor of the wrist band selects one of the plurality of activation patterns based upon the type of call and notifies the human user of the call received from the human caller via the selected vibration pattern; and
a processor of the wrist band that detects one of a plurality of predetermined hand motions of the human user in response to the call via a motion sensor within the wrist band and sends a predetermined instruction associated with the detected hand motion to the cellphone for handling the call.
